(19) United States
(12) Patent Application Publication
(10) Pub. No.: US 2006/0197047 A1
(43) Pub. Date: Sep. 7, 2006

(54) TENSIONING DEVICE

(76) Inventors: Ronald H. Batcher, Schenectady, NY (US); William F. Ross, Ballston Lake, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/419,256

(22) Filed: May 19, 2006

Related U.S. Application Data
(63) Continuation of application No. PCT/US04/39601, filed on Nov. 24, 2004.
(60) Provisional application No. 60/525,404, filed on Nov. 26, 2003.

(51) Int. Cl. F16K 25/00

(52) U.S. Cl. 251/170

(57) ABSTRACT

The present invention provides a tensioning device capable of reducing the gap between proximate plates in a valve mechanism and thereby reducing or preventing the leakage of fluid through a valve. A first aspect of the invention provides a valve mechanism comprising a valve body, a first plate having at least one opening, a second plate having at least one opening and residing proximate the first plate, and a tensioning device for decreasing a gap between a surface of the first plate and a surface of the second plate.

### CROSS REFERENCE TO RELATED APPLICATIONS

This is a continuation of International Application PCT/US2004/039601, with an International Filing Date of Nov. 24, 2004, currently pending, which claims priority to U.S. Provisional Patent Application 60/525,404, filed Nov. 26, 2003, both of which are hereby incorporated by reference herein.

### BACKGROUND OF THE INVENTION

(1) Technical Field

The present invention relates generally to tensioning devices and more particularly to devices for increasing tension between valve components.

(2) Related Art

Valve devices have long been used to control the flow of fluids (i.e., liquids and gasses) within fluid delivery systems. Most often, valve devices are used to open or close a portion of the delivery system to the flow of a fluid. Such opening and closing may be partial, e.g., to regulate the rate of fluid flow, or complete.

Various internal valve mechanisms have been employed for such purposes, including, for example, ball mechanisms, gate mechanisms, and butterfly mechanisms. Other mechanisms employ two or more proximally-spaced plates, wherein each plate contains at least one opening, such that the movement of one or more of the plates along its plane of contact with a proximate plate will either bring the openings in each plate into alignment, thus permitting fluid flow, or will move the openings in each plate out of alignment, thus restricting or preventing fluid flow. Such mechanisms are preferred for some applications, as they are known to suppress vibrations, pressure fluctuations, cavitation, and noise.

One problem with such mechanisms, however, is that it is often difficult or impossible to reduce the gap between proximate plates to such a degree that fluid flow is entirely prevented. That is, where the gap between the proximate plates is large enough, fluid will continue to flow through the valve even when the openings in the plates are completely unaligned, albeit at a reduced rate. Such leakage is more severe where the fluid delivery system is operated under pressure.

Accordingly, there is a need in the art for a valve device capable of preventing or greatly reducing fluid leakage between unaligned proximate plates.

### SUMMARY OF THE INVENTION

The present invention provides a tensioning device capable of reducing the gap between proximate plates in a valve mechanism and thereby reducing or preventing the leakage of fluid through a valve. A first aspect of the invention provides a valve mechanism comprising a valve body, a first plate having at least one opening, a second plate having at least one opening and residing proximate the first plate, and a tensioning device for decreasing a gap between a surface of the first plate and a surface of the second plate.

A second aspect of the invention provides a valve mechanism comprising a valve body, a fixed plate having at least one opening, a linearly-movable plate having at least one opening and residing proximate the fixed plate, and a tensioning device for decreasing a gap between a surface of the fixed plate and a surface of the linearly-movable plate.

A third aspect of the invention provides a tensioning device comprising a ring member capable of placement proximate a movable valve component, and a tensioning member, wherein the tensioning member is capable of engaging the ring member and a fixed valve component to reduce a gap between the ring member and the movable valve component.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a cross-sectional view of a valve mechanism according to the present invention.

FIG. 2 shows a cross-sectional view of a tensioning device according to the present invention.

FIGS. 3A-B show cross-sectional views of a valve mechanism in its open and closed positions, respectively, to which the tensioning device of the present invention may be applied.

### DETAILED DESCRIPTION OF THE INVENTION

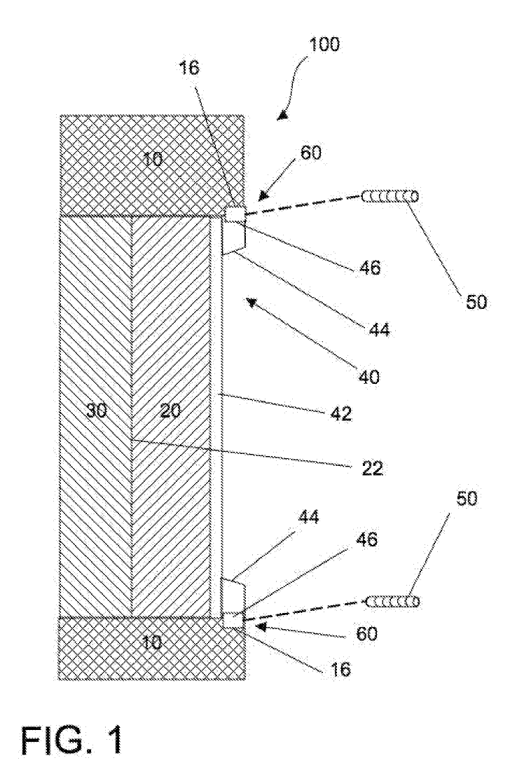

Referring to FIG. 1, a valve mechanism 100 according to the present invention is shown comprising a valve body 10, a first plate 20, a second plate 30, a ring member 40, and a tensioning member 50. First plate 20 and second plate 30 are proximally-located, usually with a gap 22 between.

Ring member 40 is located proximate first plate 20. As shown, ring member 40 comprises a ring body 42 and one or more attachment body 44. While described as a ring, it should be noted that ring member 40 may be of any of a number of shapes. Generally, the shape of ring member 40 approximates that of first plate 20 and may be square, rectangular, triangular, octagonal, etc. Similarly, while ring member 40 is shown as comprising distinct parts (ring body 42 and attachment body 44), it should be appreciated that ring member 40 may comprise a single element capable of performing the functions of both, as described below.

Gap 22 may be reduced or eliminated, by tensioning ring member 40 against first plate 20, which in turn is pressed against second plate 30. Ring member 40 is so tensioned by insertion of tensioning member 50 into engagement 60. Engagement 60 is an opening into adjacent portions of valve body 10 and attachment body 44. That is, engagement 60 may be viewed as being comprised of a valve body opening 16 and an attachment body opening 46. Accordingly, engagement 60 may be formed (e.g., by drilling) after ring member 40 is placed proximate valve body 10 or may result when an attachment body 44 having an attachment body opening 46 is placed proximate a valve body 10 having a valve body opening 16 such that adjacent attachment body opening 46 and valve body opening 16 form engagement 60. Generally, engagement 60 is circular in cross-section, but this is not necessary.

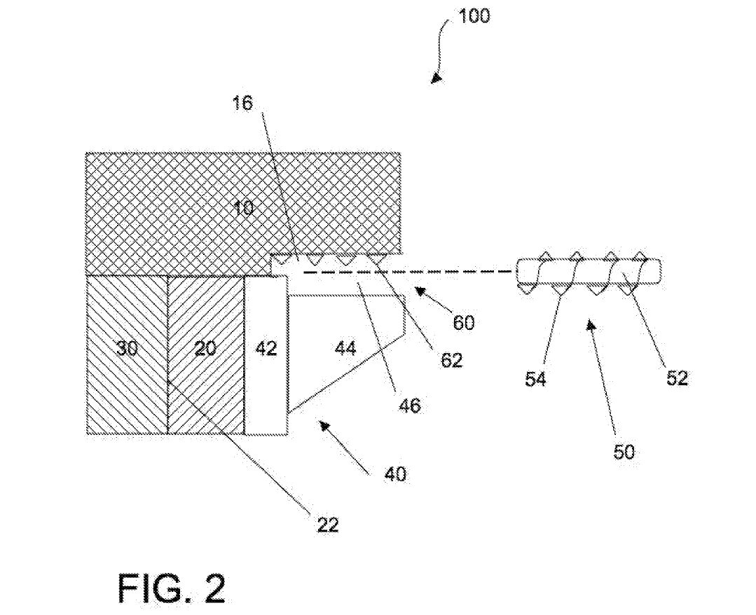

Tensioning member 50, upon its insertion into engagement 60, is capable of engaging both valve body 10 and attachment body 44, thus providing tension against first valve 20 via ring body 42. Referring now to FIG. 2, which depicts a portion of valve mechanism 100 in greater detail, tensioning member 50 has an elongate body 52. Preferably, at least a portion of a surface of tensioning member 50 includes threads 54 which correspond to threads 62 within engagement 60. In a particularly preferred embodiment, tensioning member 50 is a set screw. In such an embodiment, the threading of tensioning member 50 into engagement 60 will force attachment body 44 and ring body 42 against first plate 20, which in turn will reduce gap 22 between first plate 20 and second plate 30.

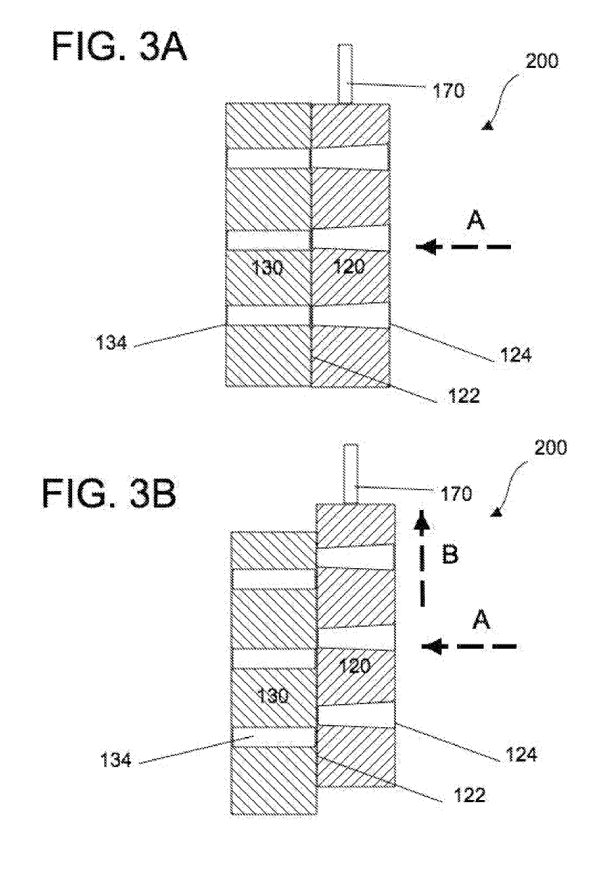

Referring to FIGS. 3A-B, a valve mechanism 200 is shown to which the tensioning device of the present invention may be usefully employed. Referring to FIG. 3A, the valve mechanism 200 is shown in its open position, wherein one or more openings 124 in a first plate 120 are aligned with one or more openings 134 in a second plate 130. Each plate 120, 130 may contain a plurality of openings 124, 134. As a fluid flows in direction A, it passes through openings 124, 134 in the plates 120, 130. At least one of the first plate 120 and second plate 130 is fitted with a moving device 170 for linearly moving the plate. In a preferred embodiment, first plate 120 is linearly movable and upstream of second plate 130, which is fixed. As described above, a gap 122 generally exists between first plate 120 and second plate 130.

Referring now to FIG. 3B, valve mechanism 200 is shown in its closed position, wherein first plate 120 has been moved in linear direction B by moving device 170 such that openings 124 in first plate 120 no longer align with openings 134 in second plate 130. In such a position, gap 122 provides a pathway for fluid flow between opening 124 and opening 134. However, the application of the tensioning device of the present invention, as described above with reference to FIGS. 1-2, reduces or eliminates gap 122, restricting or preventing fluid flow between opening 124 and opening 134.

While FIGS. 3A-B depict a two-plate valve mechanism, it should be recognized that the tensioning device of the present invention may be used to improve the function of other valve mechanisms. For example, the tensioning device of the present invention may be used in a single-plate valve mechanism having a single movable valve component, such as a gate valve, by tensioning a ring member against the plate, which in turn is tensioned against the valve body. Similarly, while the tensioning device has been depicted as engaging the valve body, it should be understood that it could similarly engage any other fixed valve component.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A valve mechanism comprising:
a valve body;
a first plate having at least one opening;
a second plate having at least one opening and residing proximate the first plate; and
a tensioning device for decreasing a gap between a surface of the first plate and a surface of the second plate.

2. The valve mechanism of claim 1, wherein the tensioning device comprises:
a ring member; and
a tensioning member having an elongate body capable of engaging the ring member and the valve body.

3. The valve mechanism of claim 2, wherein a portion of each of the ring member and the valve body engaged by the tensioning member is adjacent the other.

4. The valve mechanism of claim 2, wherein each of a surface of the elongate body, a portion of the ring member engaged by the tensioning member, and a portion of the valve body engaged by the tensioning member are threaded.

5. The valve mechanism of claim 2, wherein a surface of the ring member resides proximate a surface of one of the first plate and the second plate.

6. The valve mechanism of claim 1, wherein each of the first and second plates includes a plurality of openings such that moving at least one of the first and second plates aligns each of the plurality of openings.

7. The valve mechanism of claim 1, wherein at least one of the first plate and the second plate is movable.

8. A valve mechanism comprising:
a valve body;
a fixed plate having at least one opening;
a linearly-movable plate having at least one opening and residing proximate the fixed plate; and
a tensioning device for decreasing a gap between a surface of the fixed plate and a surface of the linearly-movable plate.

9. The valve mechanism of claim 8, wherein the tensioning device is located proximate the linearly-movable plate.

10. The valve mechanism of claim 8, wherein the tensioning device comprises:
a ring member; and
a tensioning member having an elongate body capable of engaging the ring member and the valve body.

11. The valve mechanism of claim 10, wherein a portion of each of the ring member and the valve body engaged by the tensioning member is adjacent the other.

12. The valve mechanism of claim 10, wherein each of a surface of the elongate body, the portion of the ring member engaged by the tensioning member, and a portion of the valve body engaged by the tensioning member are threaded.

13. The valve mechanism of claim 10, wherein a surface of the ring member resides proximate a surface of one of the fixed plate and the linearly-movable plate.

14. The valve mechanism of claim 8, wherein each of the fixed and linearly-movable plates includes a plurality of openings such that moving the linearly-movable plate aligns each of the plurality of openings.

15. The valve mechanism of claim 8, wherein the linearly-movable plate is located upstream from the fixed plate.

16. A tensioning device comprising:
a ring member capable of placement proximate a movable valve component; and
a tensioning member,
wherein the tensioning member is capable of engaging a portion of the ring member and a portion of a fixed valve component to reduce a gap between the ring member and the movable valve component.

17. The tensioning device of claim 16, wherein the movable valve component is a plate.

18. The tensioning device of claim 16, wherein the movable valve component is movable in a linear direction.

19. The tensioning device of claim 16, wherein the fixed valve component is a valve body.

20. The tensioning device of claim 16, wherein the portion of the ring member engaged by the tensioning member is adjacent the portion of the fixed valve component engaged by the tensioning member.
